(19) United States
(12) Patent Application Publication
(10) Pub. No.: US 2021/0056875 A1
(43) Pub. Date: Feb. 25, 2021

(54) SOLAR PANEL LIGHTING FOR HOUSE NUMBER DEVICE

(71) Applicant: Calixte A Zinsou, Lake Grove, NY (US)

(72) Inventor: Calixte A Zinsou, Lake Grove, NY (US)

(21) Appl. No.: 16/548,665

(22) Filed: Aug. 22, 2019

(51) Int. Cl. G09F 13/22; G09F 27/00; G09F 13/04

(52) U.S. Cl. CPC G09F 13/22; G09F 2013/222; G09F 13/04; G09F 27/007

(57) ABSTRACT

An illustrated view of an exemplary house number lighting device for providing illumination of an identifier to identify a house is presented. The exemplary house number lighting device is useful for replacing a current numbering apparatus for a house that is either unreadable or is difficult to read resulting in people can cause traffic concerns by slowing down or stopping to verify a house number, going to the wrong house or becoming frustrated finding particular house and not going to the house. Thus, the exemplary house number lighting device is useful for providing twenty-four (24) hour visibility of the house number of a house. The device has a panel, a solar panel and one or more housing numbers. An awning like structure overhangs a front of the panel where the numbers are located. The solar panel is coupled to the top of the panel and powers one or more lights that are coupled under the awning portion of the top of the panel for illuminating the numbers when it is low-light.

### FIELD OF THE INVENTION

This invention relates to house numbers. More particularly, it relates to lighting device for house numbers.

### BACKGROUND

House numbering is the system of giving a unique number to each building in a street or area, with the intention of making it easier to locate a particular building. The house number is often part of a postal address. The term describes the number of any building (residential or not) with a mailbox, or even a vacant lot.

House numbering schemes vary by location, and in many cases even within cities. In some areas of the world, including many remote areas, houses are named but are not assigned numbers.

In the United States and Canada, streets are usually numbered with odd on one side and even on the other. The specific ordering of the numbers varies based on the policies of the local municipality. Generally, three different systems exist:

1) Streets may be numbered strictly sequentially, starting with 1 at the start of the street, and continuing in order skipping no numbers until the end. In these cases, if additional addresses are needed to be assigned to new buildings, fractional house numbers may be used, or letter suffixes may be appended to the house number.

2) Streets may be numbered from the most recent intersection. In these cases, numbers progress sequentially from each intersection, but skip to the next set of numbers at each cross street, usually in sets of even 100s. Thus, the first block on a street may start at 1, and continue up until the next block, when they start at 101, then 201, and so on.

3) Streets may be numbered based on distances, where the house number is based on some mathematical formula according to the distance from the start of the numbering system. Thus, a property numbered 1447 may be approximately 1.5 miles from the beginning point for the numbering system.

Even within these systems, there are also two ways to define the starting point for the numbering system. Some places will start the numbering system at the start of the street itself. Other places will define a numbering system based on a defined point or line, such as a municipal or county boundary, or a defined intersection near the center of the municipality, with numbers increasing generally as one gets further from the baseline, regardless of where streets start or stop.

Lighting or illumination is the deliberate use of light to achieve a practical or aesthetic effect. Lighting includes the use of both artificial light sources like lamps and light fixtures, as well as natural illumination by capturing daylight. Daylighting (using windows, skylights, or light shelves) is sometimes used as the main source of light during daytime in buildings. This can save energy in place of using artificial lighting, which represents a major component of energy consumption in buildings. Proper lighting can enhance task performance, improve the appearance of an area, or have positive psychological effects on occupants.

House numbers are very often dark as the outdoor lighting is generally further away and may have obstacles preventing the lighting from properly illuminating the house numbers. When house numbers are hard to read or cannot be read at night, often people can cause traffic concerns by slowing down or stopping to verify a house number or can miss going to the right house.

In light of the foregoing, it would be desirable to devise an improved housing number lighting device to properly address at least the foregoing problems.

### BRIEF DESCRIPTION OF THE DRAWINGS

FIG. 1A is an illustrated view of an exemplary house number lighting device.

FIG. 1B is an illustrated view of an exemplary lights of the exemplary house number lighting device shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

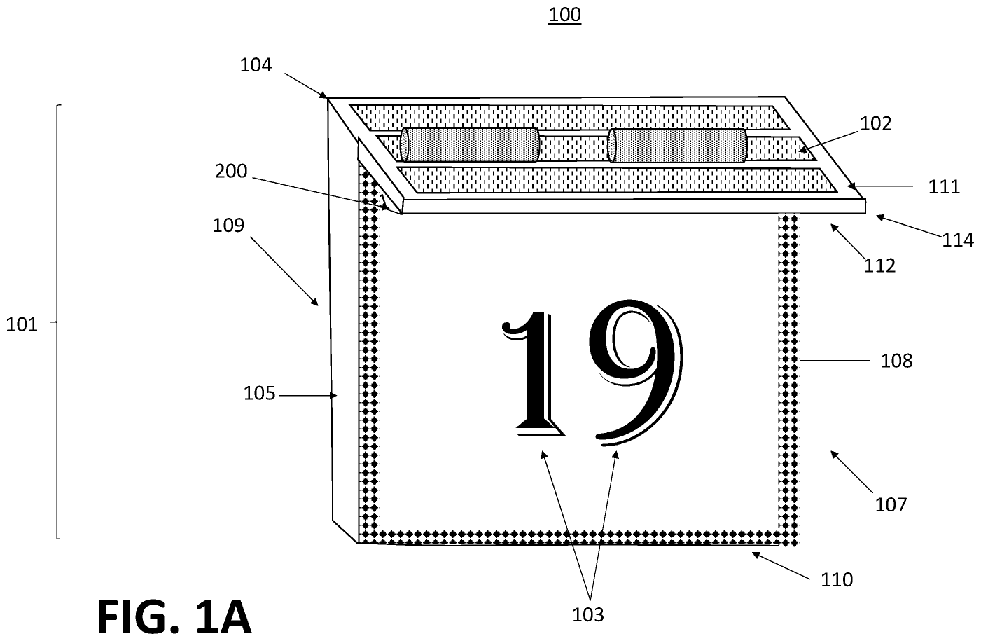

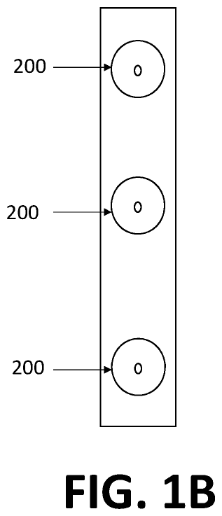

Referring to FIG. 1A and FIG. 1B, an illustrated view of an exemplary house number lighting device for providing illumination of an identifier to identify a house is presented. The exemplary house number lighting device 100 is useful for replacing a current numbering apparatus for a house that is either unreadable or is difficult to read resulting in people can cause traffic concerns by slowing down or stopping to verify a house number, going to the wrong house or becoming frustrated finding particular house and not going to the house. Thus, the exemplary house number lighting device 100 is useful for providing twenty-four (24) hour visibility of the house number of a house.

The exemplary house number lighting device 100 has a panel 101, a solar panel 102 and one or more identifiers 103. The panel 101 is preferably made of a plastic material, but other materials are hereby contemplated, including, but not limited to, poly-vinyl chloride (PVC), wood, aluminum, a composite material, etc.

The panel 101 has a top 104, a first side 105, a second side 107, a front 108, a back 109 and a bottom 110. The panel 101 is preferably six (6) inches in height, but other heights are hereby contemplated, including, but not limited to, four (4) inches, eight (8) inches, one (1) foot, etc. The panel 101 is preferably six (6) inches in width, but other widths are hereby contemplated, including, but not limited to, four (4) inches, eight (8) inches, one (1) foot, etc. The panel 101 is preferably two (2) inches in depth, but other depths are hereby contemplated, including, but not limited to, one (1) inch, three (3) inches, etc. The panel 101 is preferably rectangular in shape, but other shapes are hereby contemplated, including, but not limited to, square, round, oblong, trapezoidal, etc.

The back 109 of the panel 101 is preferably coupled to an exterior wall (not shown) of a house (not shown) by a coupling device (not shown). The coupling device is preferably a screw, but other types of coupling devices are hereby contemplated, including, but not limited to, a nail, Velcro, adhesive, etc.

The one or more identifiers 103 are removably coupled to the front 108 of the panel 101. The one or more identifiers 103 are preferably numbers, but other identifiers are hereby contemplated, including, but not limited to, alpha-numeric, alphabetic characters, icons, braille, etc.

The top 104 of the panel 101 having an awning 114 that extends over the front 108 of the panel 101. The top 104 preferably has a length of two (2) inches greater than the width of the panel 101, but other lengths are hereby contemplated, including, but not limited to, one (1) inch, three (3) inches, etc.

The top 104 of the panel 101 has a first side 111 and a second side 112. The first side 111 of the top 104 of the panel 101 has a solar panel 102. The solar panel 102 is useful for receiving solar energy from the sun and converting the solar energy.

The second side 112 of the top 104 has one or more lights 200 of FIG. 1B. The one or more lights 200 are preferably light emitting diode (LED) lamps, but other types of lights are hereby contemplated, including, but not limited to, liquid crystal display (LCD), fluorescent, etc. The one or more lights 200 being electrically coupled to the solar panel 102 of the house number lighting device 100. The one or more lights 200 being substantially on the second side 112 of the awning 114 of the top 104 of the panel 101.

The solar panel 102 may optionally and/or additionally have a photocell sensing device for illuminating the lighting the one or more lights 200 in a low-light environment.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A house number lighting device for lighting house numbers, the device comprising:
a panel, the panel having a back, a front and a top;
an awning, the awning being coupled the top of the panel, wherein the awning being extended past the front of the panel;
one or more lights, wherein the one or more lights being coupled to the awning, wherein the one or more lights being on a second side of the awning of the top of the panel;
a photocell sensing device, wherein the photocell sensing device is configured for illuminating the one or more lights in low-lights environments;
one or more identifiers, the one or more identifiers for uniquely identifying a house, and wherein the one or more identifiers being removably coupled to the front of the panel; and
a solar panel, the solar panel being for providing electrical energy to the one or more lights.

2. The device of claim 1, wherein the device being a rectangular shape.

3. The device of claim 1, wherein the one or more lights being light emitting diode (LED) lamps.

4. The device of claim 1, wherein the device being made of a plastic material.

5. The device of claim 1, wherein the device being six (6) inches in length.

6. The device of claim 1, wherein the device being six (6) inches in height.

7. The device of claim 1, wherein the device being two (2) inches in depth.

8. The device of claim 1, wherein the identifiers being numbers.

9. The device of claim 1, wherein the identifiers being alpha-numeric.

10. (canceled)
